(19) United States
(12) Patent Application Publication
(10) Pub. No.: US 2015/0132562 A1
(43) Pub. Date: May 14, 2015

(54) COMPOSITE COATING COMPOSITION AND METHOD OF APPLICATION

(71) Applicant: Peter Paul Roosen, Wellington (CA)

(72) Inventor: Peter Paul Roosen, Wellington (CA)

(21) Appl. No.: 14/076,814

(22) Filed: Nov. 11, 2013

(51) Int. Cl. C09D 5/08; B05D 1/02; B05D 7/00

(52) U.S. Cl. CPC C09D 5/08; B05D 7/542; B05D 1/02; B05D 7/582
USPC 428/304.4; 427/385.5; 427/8; 427/140; 428/339

(57) ABSTRACT

An improved coating for rigid and semi-rigid substrates, in particular for equipment used in the oil and gas hydraulic fracturing or fracking industry. The coating is a composite of a relatively thick elastomeric primer coat layer and a harder top coat layer (e.g. epoxy type). The composite has advantageous durability, in particular a surprisingly good resistance to chemical attack.

### FIELD OF THE INVENTION

The present invention relates to a multi-layer composite composition and method of coating rigid and semi-rigid substrates for increased corrosion and chemical resistance and increased resistance to abrasion and mechanical damage. Substrates which need such protection are those having a surface which is intended to be in contact with water and other liquids or slurries containing mixtures of solids and liquids such as those used in oil and gas industry hydraulic fracturing or “fracking” operations.

### BACKGROUND OF THE INVENTION

Protective coatings are extensively used to protect steel, concrete and other surfaces from corrosion, abrasion, chemical and mechanical damage. Coatings are also employed for aesthetic reasons. The trend has been toward increasing the amount of such surfaces thus protected. In recent years, it has become the norm for practically all steel surfaces to be coated, whether or not they are exposed to water or other corrosive elements. Increasingly, concrete surfaces are also being coated. Semi-rigid surfaces such as pond or secondary containment lining membranes and the inside or outside surfaces of flexible hoses are also being coated, either in a factory environment or out in the field.

There are many different kinds of protective coatings available, most of which are applied over surfaces which need to be specially prepared by sandblasting or other means. Typically, steel surfaces need to be blast cleaned to a white or near-white condition with sufficient blast profile to provide enough roughened surface area to clear away any contaminants and provide a good anchor profile. Coatings can be single-layer or multi-layer composites. In the case of composites, the layers can be comprised of one coating formulation or with differing layers comprised of different formulations. Contaminants and insufficiently prepared surfaces are responsible for large numbers of coating failures, usually evidenced by the coating cracking, peeling, blistering or otherwise separating from the substrate. It is therefore very important that surface preparation operations are conducted in such a manner as to be consistent with the requirements for a particular coating.

Normally, successive coats require either partial or complete curing of the preceding layer prior to application of successive layers. This is especially important in solvent-based coating formulations where it is desired to have the solvents escape from the applied coating and not become trapped in or between the previously applied layer(s). This becomes less important in cases where the coating formulations are comprised of 100% solids, where nothing escapes the initially applied coating. It is important to ensure there is chemical compatibility between the formulations used in successive coatings, such that the coating layers adhere to each other sufficiently to avoid blistering, peeling or other undesirable effects. There are, however, some coatings such as certain epoxy or polyurea based formulations, where successive coats are required to be applied before complete curing has occurred. In these instances, a subsequent layer applied to a previously applied layer which has been allowed to first fully cure, may not adhere sufficiently to said previous layer. As in the case of surface preparation operations, it is very important to ensure that coating application operations are conducted in such a manner as to be consistent with the requirements for a particular coating or composite coating system.

Spray applied plural component thermoplastic and thermosetting materials have gained wide commercial acceptance as protective and decorative coatings. Similarly, spray applied foams are in widespread use throughout the world. There is a large body of prior art with respect to these types of materials that usually come as two part formulations in which the respective parts chemically combine into finished form once dispensed from the spraying system. The cure rates and gel times vary widely for the various formulations from several hours to less than 10 seconds. In many formulations, the rates can be modified through the use of varying temperatures, types and amounts of catalysts and other means.

Plural component formulations occasionally come in 3, 4 or more parts, but this is not the norm. The vast majority of plural component systems are two part systems. The respective components of a plural component system are often identified as a Part A and Part B respectively, with additional Part C, Part D, etc. in instances where there are more than the typical two fluid components involved. For purposes of this disclosure, the typical two part system and nomenclature will be used throughout, although the applicant's intention is to not limit the scope of disclosure and claims to only two component systems by doing so. It is an accepted well known practice to introduce catalysts (accelerators), blowing agents, coloring agents, etc. as separate components in a plural component system rather than pre-blending such ingredients into one of the fluid components of a plural component system. However, describing these more complex systems can become cumbersome so the applicant respectfully asks readers to consider a plural component system as being defined herein as a formulation that comes in two or more parts.

Many formulations employ solvents in varying types and amounts, either within the formulations themselves or to clean and purge some or all of the equipment components of the spraying systems. U.S. Pat. No. 4,695,618, issued to Norman R. Mowrer in 1987, discloses that a then “growing emphasis on compliance with government environmental and health regulations that limit both the type and amount of volatile organic compounds (VOC) has prompted coating manufacturers and end users to evaluate new coating technologies” (Column 1, Row 40-44). Since that time, manufacturers have produced an increasing number of formulations that are described in the art as being as much as 100% solids—a term used to describe the percentage of the ingredients that remain in the formulations after completion of the cure cycle. This confirms there has in fact been a long felt need to reduce or eliminate the use of said solvents and other volatile components from formulations and also from equipment purging and cleaning processes.

Manufacturers of formulations and equipment respectively are having difficulties developing new technologies that meet the tightening environmental and health requirements while meeting customer and end user demands for better solutions without increasing costs. In particular, eliminating the use of solvents has made it much more difficult to develop improved formulations that maintain 1:1 volumetric ratios with matched viscosities. The trend has been toward formulations that have widening ratios with 4:1 currently considered the maximum viable ratio. It is desired to have spraying systems that go beyond this to accommodate in excess of 10:1 for some formulations. Generally, the widely held perception is that the further a ratio moves from 1:1, the more difficult it becomes to successfully mix and dispense the material. Viscosities are similarly becoming more divergent. They are generally increasing, with formulations known in the art that have viscosities increasing to as much as 1,000,000 CPS (centipoises). In comparison, other materials have much lower viscosities, as little as 5 CPS. It has therefore become a common practice to include elaborate heating systems to decrease the viscosity of thick materials such that they can be successfully pumped, mixed and dispensed using spraying technology.

U.S. Pat. No. 5,344,490, issued to Peter Paul Roosen et al. in 1994, discloses a plasticised gypsum composition that includes plural component formulations that have volumetric ratios ranging between 4:1 to 9:1 and large differences in viscosity between the respective Part A and Part B components. Roosen is one of the applicants herein and the disclosure of the '490 patent is incorporated herein by reference. Roosen '490 formulation Example 1 is for a plural component gypsum composition that contains 41% PBW (parts by weight) gypsum in total and is typically prepared in two parts with Part A being the gypsum and various other ingredients totalling 83% PBW and Part B being the balance 17% isocyanate. This 5:1 PBW ratio translates to a volumetric ratio of approximately 4.5:1 which is not a standard industry ratio and has therefore been difficult to dispense by means of a solvent-free spray application using conventional off the shelf equipment. US 2013/0015262, (Ryan Winston Monchamp and Peter Paul Roosen—Roosen being the applicant herein), which is hereby incorporated by reference, discloses a solvent-free plural component spraying system and method that has been successfully applying the above Roosen '490 formulation as well as other formulations to various rigid and semi-rigid substrates, including tanks, pipes, tubes, decks, panels and other substrates made from steel, wood, concrete, geotextile fabrics and other materials.

The marine, oil and gas, chemical, mining, military and aerospace industries are among areas where the most advanced forms of protective coatings, designed to withstand harsh environments for long periods of time, have flourished in recent decades. There is a considerable body of prior art related to such coating compositions and systems which generally share an engineering approach to solving technical problems associated with protective coatings in a commercially viable manner. The state of the art at present largely consists of a wide array of custom engineered corrosion protection solutions tailored to solving particular problems, often for particular industries.

As an example, U.S. Pat. No. 5,192,603, issued to William W. Slater et al. in 1993 discloses a composite coating and process intended for use in the marine industry for protecting a rigid substrate against aquatic fouling. The Slater '603 patent describes a two layer composite coating wherein the properties of the respective layers and the application process are optimized to achieve a particular set of results. In this case, an elastomeric undercoat used to promote intercoat adhesion is used in combination with a softer top coat of a room temperature vulcanisable silicone rubber resulting in a system providing maximum resistance to aquatic fouling while also increasing the resistance of the top coat silicone rubber to damage by abrasion, tearing or cutting by absorbing abrasive energy.

An example in a different industry, U.S. Pat. No. 5,300,336, issued to Dennis Wong et al. in 1994, discloses a composite protective pipe coating directed towards steel pipes and pipelines. This example is a powder coating technology that employs a combination of fusion bonded epoxy resin primer and fusion bonded polyolefin outer sheath with an interlayer of graded epoxy resin and polyolefin. This is a three layer composite coating system to increase the resistance of the coated pipe to mechanical damage during pipe installation and moisture permeation over time as compared to fusion bonded epoxies used in isolation.

From the above two examples and an examination of the prior art as a whole, there does not appear to be a general protective coating system in existence that is capable of meeting the requirements of a wide range of industries and applications where the technical demands are relatively high. Such a universal coating system and application method would be desirable and there has been a long felt need for it.

There is a relatively new and rapidly growing area of interest in utilizing improved protective coatings, namely the burgeoning hydraulic fracturing or “fracking” practice and trade within the oil and gas industry. Coatings traditionally used in the marine, chemical, mining, military and aerospace industries have largely proven to be inadequate for meeting the severe technical demands of the fracking trade, especially where acids and other strong chemicals are employed to aid in fracturing the oil and gas formations deep within the earth's surface.

Coating longevity that has been measured in years for fracking equipment, with 2 to 3 or more years having been the norm has been decreasing dramatically during the last decade. This is directly related to increased acidization associated with improvements being made in fracking practices. The quantities, concentrations and tendencies to mix different types of acids using the same equipment are all on the increase. Currently, average coating life spans are measured in months, with 3 to 8 months being the average coating life as experienced by various contractors providing acid transports and tanks and the fluid transportation, mixing, storage, pumping and handling services. It is not uncommon for new and newly coated tanks to fail within 1 to 4 hours of being initially placed into service. Some contractors are employing fiber reinforced plastic (FRP) type coatings while others are using hot or cold molded polyethylene and polypropylene coatings of high thicknesses. These are very expensive options when compared to spray-in-place coatings.

The available spray-in-place coatings currently in use with acid fracking operations are generally organic. They are normally selected from among the polyurethane, polyurea, polyester, vinyl ester and epoxy types. The epoxy type generally has the highest chemical resistance from among these types and is therefore preferred. When used in isolation, none of these generally have sufficient substrate adhesion, flexibility, strength and chemical resistance to withstand the induced mechanical, thermal and chemical stresses that are encountered frequently in the oil and gas industry. This is an industry in which equipment is normally roughly handled and operated through extremes of climate and weather in conjunction with large variations in temperatures, pressures and chemical mixtures often occurring simultaneously. Equipment made from stainless steels and other alloy steels also tend to fail too quickly in these applications. A universal solution has not yet been invented or discovered.

Epoxy type coatings which meet most of the chemical resistance requirements, tend to crack and delaminate from the substrates due to insufficient flexibility and adhesive qualities. Polyurethane, polyester, vinyl ester and polyurea type coatings tend to lack sufficient chemical resistance properties to handle the various mixtures of acid solutions and other chemicals. Coating repairs for all of these are usually difficult to effect because patches often do not adhere sufficiently well to previously coated areas. This often requires replacement of equipment or removal and replacement of entire coatings which can become very expensive in terms of time, money and effort.

Reinforcement fiber materials can be introduced into these coatings, via chopper guns during spraying operations, or by other means. Such fiber reinforced plastic (FRP) coatings tend to be rather costly in comparison to coatings which do not include fiber.

US 2011/0262733, (Peter Paul Roosen et al.—Roosen being the applicant herein), which is hereby incorporated by reference, discloses a composition comprising purposely oriented lignocellulosic fiber bound to an inorganic hydrate such as gypsum in the absence of water by a polymer. This has relevance when considering options for introducing fiber material into coatings which include inorganic hydrates.

Other types of coatings which often meet most chemical resistance requirements such as roto-molded polyethylene linings or fused butyl rubber linings are difficult and expensive to install and often fail to adhere to the substrate sufficiently. They also tend to have too little resistance to certain chemicals such as xylene which are in widespread usage in fracking operations, either in isolation or as part of mixtures with concentrates of strong acids including hydrochloric (up to 38% concentration) and hydrofluoric (up to 49% concentration). Fracking mixtures include a wide assortment of chemicals. There is often great variation of the mixtures during fracking operations as technicians and chemists make adjustments during operations to address the varying conditions encountered in the below ground hydrocarbon bearing geologic formations.

Spray-in-place epoxies have become the preferred type of coating for lining equipment used in fracking operations, mainly due to their excellent resistance to most of the chemicals and chemical mixtures encountered in fracking operations, combined with fairly high abrasion resistance and the convenience of being able to install them at relatively modest cost through quick and efficient spraying means. Such epoxy coatings, however, have some serious drawbacks, as evidenced by large numbers of widespread failures throughout the industry currently being experienced on a daily basis throughout the world. Most, but certainly not all, of these failures can be attributed to imperfect preparation of the substrates or imperfect application. Unfortunately, it is very difficult to achieve perfection in terms of both surface preparation and application. This is partly due to some technical properties of epoxies which created the need for high standards of surface preparation and application as shall be further described herein.

The terms “epoxy” and “epoxies” are used to describe both the basic components and the cured end products of epoxy resins. It is also a colloquial name for the epoxide functional group. Epoxy resins, also known as polyepoxides, are a class of reactive prepolymers and polymers which contain epoxide groups. Epoxy resins are low molecular weight pre-polymers of higher molecular weight polymers which normally contain at least two epoxide groups. A wide range of epoxy resins are manufactured.

Epoxy resins may be reacted either with themselves through catalytic homopolymerization, or with a wide range of co-reactants including polyfunctional amines, acids, acid anhydrides, phenols, alcohols and thiols to form highly cross-linked cured end products. These co-reactants are often referred to as hardeners or curatives and the cross-linking reaction is commonly referred to as curing. Epoxies are typically cured with at or near stoichiometric quantities of curative to achieve maximum physical and chemical resistance properties. Reaction of polyepoxides with themselves or with polyfunctional hardeners forms a thermosetting polymer. The cured end products normally have strong mechanical properties and high chemical resistance.

Different grades of epoxy resin are often blended with various plasticizers, fillers, pigments and other additives to achieve desired processing and final properties.

The most common and important class of epoxy resins is formed from reacting bisphenol-A with epichlorohydrin to form diglycidyl ethers of bisphenol-A. Bisphenol-F may also similarly undergo epoxidation and these bisphenol-F epoxy resins have lower viscosity and a higher mean epoxy content per unit mass which gives the cured products increased chemical resistance. Reaction of phenols with formaldehyde and subsequent glycidylation with epichlorohydrin produces epoxidised novolacs, such as epoxy phenol novalacs and epoxy cresol novalacs with typical mean epoxide functionality of around 2 to 6. The high functionality of these resins forms a highly cross-linked polymer with high chemical resistance but low flexibility.

Curing of epoxy resins is an exothermic process which can produce sufficient heat to cause thermal degradation if not controlled. The epoxy curing reaction may be accelerated by addition of small quantities of accelerators such as tertiary amines, carboxylic acids, alcohols and phenols.

Polyfunctional primary amines form an important class of epoxy hardeners. Primary amines undergo an addition reaction with the epoxide group to form a hydroxyl group and a secondary amine. The secondary amine can further react with an epoxide to form a tertiary amine and an additional hydroxyl group. Use of a difunctional or polyfunctional amine forms a three-dimensional cross-linked network. Aliphatic, cycloaliphatic and aromatic amines are all employed as epoxy hardeners. Amine type will alter both the processing properties (viscosity, reactivity) and the final properties (mechanical, temperature and chemical resistance) of the cured copolymer network. Thus amine structure is normally selected according to the application. Aromatic amines form much more rigid structures than aliphatic amines. Whilst aromatic amines were once widely used as epoxy resin hardeners due to the excellent end properties they imparted, health concerns with handling these materials means that they have now largely been replaced by safer aliphatic or cycloaliphatic alternatives.

Most epoxy coatings exhibit a certain amount of shrinkage while curing, ranging from 1 to 2% which leads to certain difficulties. Such coatings, when adhered to suitably prepared substrates, are under constant internal stress. Relatively minor induced mechanical, thermal or chemical stresses can easily cause the coating to fracture and delaminate. For this reason, epoxy type coatings generally cannot be applied in thick layers because the cumulative stress of a thick layer in tension often causes them to fracture and curl away from the substrate. This can lead to large leaks and sudden failures because large areas of the substrate such as in a steel transport tanker can be quickly exposed to attack from acids and other chemicals.

Epoxy coatings tend to have pull-off strengths from the substrate that are only a fraction, usually 20 to 50%, of their tensile strength. Although epoxy coatings tend to have high tensile strengths when compared to other coating types, the mode of failure tends to be adhesive rather than the more desirable cohesive type of failure. An adhesive failure is one in which the coating separates from the substrate completely. In the case of cohesive failure, some of the coating remains on the substrate. This is important when examining stresses. In an adhesive failure scenario, the stresses are concentrated at the boundary between the coating and substrate and it is not uncommon for corrosive chemicals to quickly creep under the coating and cause it to delaminate from substrates in the form of large peels or sheets. Where pull-off strengths are a high percentage of coating tensile strengths in the range of 98 to 100%, coatings tend to at least partially remain adhered to the substrate while stresses are distributed throughout the coating material. This normally leads to fewer and less dramatic modes of failure.

Engineers often fail to consider pull-off strengths relative to tensile strengths. They tend to look at pull-off strength numbers in isolation, figuring that the higher the number, the better the adhesion. This can be problematic. For instance, a coating material such as an epoxy with a 17 MPa (2500 psi) pull-off strength, relative to 52 MPa (7500 psi) tensile strength, which works out to 33% adhesion, may be more likely to fail than a 7 MPa (1000 psi) elastomeric coating with 98 to 100% adhesion, relative to 7 MPa (1000 psi) tensile strength.

Epoxy coatings tend to be hard, in excess of Shore D85, with low extensibility, typically less than 5%, which makes them very susceptible to cracking and delamination due their relative hardness and brittleness relative to other types of coatings and relative to substrates such as steel which has greater ability to be bent and twisted without failure then such epoxy coatings.

The types of mechanical stresses that are often encountered in the fracking trade include, but are not limited to, flexing (bending and twisting) caused by rough handling of tanks, pipes and other equipment which is mobilized and moved between various locations in the oil and gas fields. Tanks, railcars and tank transport trucks are occasionally bumped and sometimes dented. Mechanical shocks, even those that do not deform the substrate such as when a steel tank or pipe is struck with a hammer, also lead to epoxy coating failures. Mechanical stresses can also be induced through dramatic changes in pressures within the equipment. Traditional epoxy coatings tend to exhibit very high failure rates when the substrates are subjected to these above types of mechanical stress.

For epoxies, thermal stresses are not generally considered problematic because the coefficients of linear thermal expansion for epoxies can be held relatively low, and closely match the values for steel and concrete. Other types of organic coatings tend to have coefficients much higher than those for steel and concrete which are the main substrate materials used in oil and gas industry. However, it is preferred practice, wherever possible, to engineer coatings such that the coefficients are relatively close to those of the substrate materials to minimize thermally induced stresses.

Chemical stresses are those which occur when the coating is subjected to chemicals that penetrate into the coating, even to a small extent, sometimes causing them to expand or shrink. Coatings usually return to their normal state when the stress causing chemicals are no longer present. Such chemical penetration is a normal aspect of many organic coatings. In some cases, coatings may undergo fatigue from numerous repeated loading and unloading cycles, thereby limiting their service lives accordingly.

There are no known organic coatings in existence that are able to withstand each and all of the chemicals and chemical combinations used in the fracking trade. For instance, formic acids are quite destructive to virtually all spray-in-place epoxy type coatings. In fact there is no spray-in-place coating known to the applicant herein which is completely impervious to eventual attack from formic acid. Some vinyl ester and polyurethane type coatings are fairly resistant to formic acid attack, but do eventually fail. Additionally, coating compositions that are more resistant to formic acid might not be as resistant to other chemicals and therefore prove to be unsuitable for a particular use.

Primer coats are commonly used with various coating systems, solely as means to increase intercoat adhesion. They are generally applied at a thickness less 125 microns (less than 5 mils). There is also a long history of using mastics and adhesives to glue sheets of protective coverings onto substrates. Where mastics and adhesives are used, they are not cured into a dry form before applying the protective sheets and many of them are engineered to not dry out but to remain sticky and pliable throughout their service lives.

Fracking operations also include large amounts of abrasives such as sand which are mixed with the millions of gallons of chemical solutions injected into each oil well being fracked. Exposed coatings are often eroded by abrasion if they do not have sufficient resistance to this.

### OBJECTS OF THE INVENTION

It is an object of the present invention to provide an integral composite coating composition and method of application for rigid and semi-rigid substrates such that the coating in combination with substrate has a far better capability of performing satisfactorily in the intended applications as compared to existing traditional combinations. This requires the coating to have greater adhesion to substrate characteristics, sufficient resistance to various acids and other chemicals, particularly those used in the burgeoning fracking trade, preferably without employing the use of solvents either within the coating formulations or for cleaning and purging application equipment. Once fully cured, the composite coating needs to be able to more effectively handle mechanically, thermally and chemically induced stresses than traditional epoxy and other types of coatings while also having sufficient resistance to abrasive elements such as sand which often form part of the chemical mixtures used in fracking operations.

It is another object of the present invention to provide a method of applying the respective primer coat and top coat layers in an efficient and cost-effective manner, without the need to externally heat the substrates or to wait for long periods of time for coatings to cure. It is also desired to do so without employing solvents, either within the formulations or for cleaning and flushing out application equipment.

Although the present invention was made to satisfy the needs of the fracking trade, it is an object to have the uses extended, beyond the oil and gas industry, to others such the mining, marine, chemical, military, construction and aerospace industries.

### SUMMARY OF THE INVENTION

A composite coating composition and method of application for protecting rigid and semi-rigid substrates against corrosion comprising an elastomeric primer coat layer bonded to the substrate and a top coat layer of greater hardness than said elastomeric primer coat layer bonded to said primer coat layer. Said primer coat layer generally has adhesion characteristics such that when the composite is subjected to destructive pull-off test methods, the mode of failure is cohesive within the elastomeric primer coat layer of the composite coating composition. In addition to greater hardness, the top coat layer generally has less flexibility, greater strength, greater resistance to abrasion and greater chemical resistance than said elastomeric primer coat layer. Increased resistance to thermally-induced stresses is an additional attribute. A method of applying the composite coating comprises the steps of applying the elastomeric primer coat layer to the substrate, preferably without employing any solvents in the coating material or in the equipment used to apply said layer, curing the primer coat layer, applying the top coat layer, again preferably without employing solvents, and curing the top coat layer. The composite coating composition may also include fiber reinforcement material.

According to the invention, I have found that service life of a coating composition as applied to suitably prepared substrates can be markedly increased by the use of an improved composite coating composition and method of application to rigid and semi-rigid substrates comprising an elastomeric primer layer of even thickness applied to a suitably prepared substrate, with a harder, stronger, less flexible and generally more chemical resistant top coat layer of even thickness applied to the primer layer such that mechanically, thermally and chemically induced stresses are generally distributed relatively evenly throughout the composition, much of said stresses being particularly absorbed within the elastomeric primer coat layer.

According to another aspect of the invention, a method of applying the improved composite coating comprises applying a layer of primer coat, preferably by spraying, at least 250 microns (10 mils) thick, having a cured Shore D hardness of 20 to 60, an extensibility of 20 to 300%, and, once said primer coat layer is partially or completely cured, applying a layer of top coat, preferably by spraying, having a post-curing Shore D hardness of 60 to 95 and post-curing extensibility of less than 20%.

I have found that the thick elastomeric primer coat layer greatly increases the resistance of the top coat layer to damage by abrasion, mechanical deformation, thermal stress and chemical stress by absorbing energy and distributing stresses throughout said layer and throughout the composite. Reinforcement fiber may be added to either or both layers using a chopper gun or by other means during application of the coating layers.

Surprisingly, I have found that in addition to markedly increased service life, the resistance to chemical attack is even increased, over and above the reduction in failures arising from reduction in abrasion, mechanical deformation, thermal stress and chemically induced stress. Without being bound to a particular theory, I believe that by reducing the stress concentrations through the use of a thick elastomeric primer coat layer absorbing various stresses that would otherwise mainly be found in the coating exposed to the chemicals, the top coat layer within the present invention, said exposed coating is more “relaxed” and therefore better able to withstand chemical attack. This was an unexpected positive result.

When describing the present invention, all terms not defined herein have their common art-recognized meanings.

Further features of the invention may become apparent to those skilled in the art from a review of this summary and the following detailed description, taken in combination with the appended claims. While the invention is susceptible of embodiments in various forms, described hereinafter are specific embodiments of the invention with the understanding that the present disclosure is intended to be illustrative, and is not intended to limit the invention to the specific embodiments described herein.

The more detailed description of the preferred embodiment that follows comprises one example of the invention. Other embodiments of the invention will be apparent to those skilled in the art from the more detailed description that follows.

### DETAILED DESCRIPTION OF THE INVENTION

A suitably prepared substrate is normally achieved by means of blast cleaning. Typical blasting standards are those set out by the National Association of Corrosion Engineers or NACE and the Society for Protective Coatings or SSPC, and fall into relevant designations beginning with NACE-1 through NACE-3 for steel substrates.

### SSPC-SP5 or NACE 1—White Metal Blast Cleaning

A White Metal Blast Cleaned surface, when viewed without magnification, shall be free of all visible oil, grease, dirt, dust, mill scale, rust, paint, oxides, corrosion products, and other foreign matter. Before blast cleaning, visible deposits of oil or grease shall be removed by any of the methods specified in SSPC-SP1 or other agreed upon methods. For complete instructions, refer to Joint Surface Preparation Standard SSPC-SP5/NACE No. 1.

### SSPC-SP10 or NACE 2—Near-White Blast Cleaning

A Near-White Blast Cleaned surface, when viewed without magnification, shall be free of all visible oil, grease, dirt, dust, mill scale, rust, paint, oxides, corrosion products, and other foreign matter, except for staining. Staining shall be limited to no more than five percent of each square-inch of surface area and may consist of light shadows, slight steaks, or minor discoloration caused by stains of mill scale, or stains of previously applied paint. Before blast cleaning, visible deposits of oil or grease shall be removed by any of the methods specified in SSPC-Sp1 or other agreed upon methods. For complete instructions, refer to Joint Surface Preparation Standard SSPC-SP10/NACE No. 2.

### SSPC-SP6 or NACE 3—Commercial Blast Cleaning

A Commercial Blast Cleaned surface, when viewed without magnification, shall be free of all visible oil, grease, dirt, dust, mill scale, rust, paint, oxides, corrosion products, and other foreign matter, except for staining. Staining shall be limited to no more than 33 percent of each square-inch of surface area and may consist of light shadows, slight streaks, or minor discoloration caused by stains of rust, stains of mill scale, or stains of previously applied paint. Before blast cleaning, visible deposits of oil or grease shall be removed by any of the methods specified in SSPC-SP1 or other agreed upon methods. For complete instructions, refer to Joint Surface Preparation Standard SSPC-SP6/NACE No. 3.

For applying epoxy type coatings directly to steel substrates, surface preparation to NACE-1 (white metal) and NACE-2 (near-white metal) are required and the NACE-3 (commercial) blast cleaning is generally not sufficient, mainly due to the relatively low adhesion of epoxy type coatings when applied to steel substrates in terms of pull-off strengths being low relative to tensile strength (usually less than 50%). If the lower NACE-3 standard could be applied, that represents a substantial reduction in the amount of time and material used for the blast cleaning operation, as much as a 50% reduction in each.

For concrete substrates, the relevant NACE/SSPC blast cleaning specification designation is NACE-6.

### SSPC-SP13 or NACE 6—Concrete

This standard gives requirements for surface preparation of concrete by mechanical, chemical, or thermal methods prior to the application of bonded protective coating or lining systems. The requirements of this standard are applicable to all types of cementitious surfaces including cast-in-place concrete floors and walls, precast slabs, masonry walls and shotcrete surfaces.
An acceptable prepared concrete surface should be free of contaminants, laitance, loosely adhering concrete, and dust, and should provide a dry, sound, uniform substrate suitable for the application of protective coating or lining systems. Depending upon the desired finish and system, a block filler may be required. For complete instructions, refer to Joint Surface Preparation Standard SSPC-SP13/NACE No. 6.

The elastomeric primer coat layer can be comprised of either a thermoplastic or thermosetting composition. The elastomeric primer coat layer can be applied as a solution, emulsion or dispersion of a thermoplastic or thermoset elastomer. Preferably, it is a two part thermosetting composition that can be applied using a plural component sprayer. More preferably, it can be applied using a solvent-free spray system as disclosed in the Monchamp '262 patent application.

One example of a suitable elastomer, is the one disclosed in Slater '603. It is a “polyurethane, polyurea or poly(urethane-urea) elastomer, which can be applied as a solution in organic solvent of a preformed elastomer or as a curable mixture of an isocyanate functional material and an active hydrogen material such as a polyol and/or polyamine. A polyurethane elastomer is suitably formed from a polyisocyanate of functionality at least 2 with a polymeric polyol such as a polyether diol or triol or a polyester diol or triol, and a short chain diol having 2 to 4 carbon atoms. The polyisocyanate can for example be a diisocyanate of the formula OCN—R¹—NCO, where R¹ is an aromatic, aliphatic, araliphatic or alicyclic group having 6 to 20 carbon atoms, such as toluene diisocyanate, isophorone diisocyanate (3-isocyanatomethyl-3,5,5-trimethyl-cyclohexyl isocyanate), 1,3-bis(1-isocyanato-1-methyl-ethyl)benzene, hexamethylene diisocyanate, 1,4-bis(isocyanatomethyl)cyclohexane or bis(4-isocyanatocyclohexyl)methane. A more highly functional polyisocyanate, for example a polymethylene polyphenyl isocyanate having an average of 2.1 to 3.0 isocyanate groups per molecule, can alternatively be used. The polyether polyol is for example a polyoxyethylene glycol, polyoxypropylene glycol or poly(tetramethylene ether)glycol. If a polyester polyol is used it is preferably aliphatic, for example poly(1,4-butylene adipate). The polyether or polyester polyol preferably has a molecular weight of 600 to 4000. The short chain diol is for example ethylene glycol, propylene glycol or butane-1,4-diol.”

Slater '603 further discloses that “an ambient temperature curable polyurethane can for example comprise an isocyanate-tipped polyether diol. An ambient temperature curable polyurea can for example comprise an isocyanate-tipped polyether and a diamine, which can for example be aromatic or alicyclic such as methylene dianiline, diethylmethylbenzenediamine (which is sold as an isomeric mixture comprising mainly 2,4-diethyl-6-methyl-benzene-1,3-diamine) or bis(4-aminocyclohexyl)methane. The isocyanate-tipped polyether can for example be produced by reacting a polyether polyol as described above with a diisocyanate at a ratio of isocyanate groups to hydroxyl groups of about 2:1. Alternatively, an isocyanate-tipped polyetherurethane can be used in place of the isocyanate-tipped polyether; this can be produced by reacting a polyether polyol with a diisocyanate at a ratio of isocyanate groups to hydroxyl groups below 2:1.”

Slater '603 continues by disclosing that “an alternative thermoplastic elastomer which can be applied from organic solvent solution or aqueous emulsion is a block copolymer of at least one vinyl aromatic polymer block and at least one diene or hydrogenated diene polymer block. The block copolymer can be a diblock copolymer but is preferably a triblock copolymer of the form A-B-A, where each A represents a vinyl aromatic polymer, for example polystyrene block, and B represents a diene polymer block such as a polybutadiene or polyisoprene block or a derivative thereof in which the diene polymer blocks are hydrogenated. The diene polymer or hydrogenated diene polymer block preferably forms 50 to 80% by weight of the block copolymer, for example the vinyl aromatic polymer blocks may have a molecular weight in the range 6000 to 50000 and the diene polymer blocks may have a molecular weight in the range 30000 to 150000.”

The Slater '603 disclosure diverges from the present invention where the hardness and extensibility values are concerned. In the present invention, the elastomeric primer coat layer of the present invention preferably has an extensibility (elongation at break) of at least 20% and most preferably 30 to 200% and less than 300%. The elastomeric primer coat layer preferably has a Shore D hardness of more than 20 and most preferably less than 65, for example 40 to 60. The elastomer of the primer coat layer preferably has a resilience of at least 15%, most preferably 20 to 50%. The Slater '603 disclosure allows for too soft and too elastic a primer coat layer that, at the upper end of the Slater '603 ranges, would not provide a rigid enough base for a harder top coat layer of the present invention as disclosed herein and the pull-off strengths may also become insufficient. Additionally, the present invention described herein does not require as great a resiliency for the primer coat layer.

For coatings used in fracking equipment, the elastomeric primer coat layer is applied at a dry film thickness of at least 250 microns (10 mils), preferably at least 350 microns (15 mils) and most preferably at least 500 microns (20 mils). A thickness of 750 to 1300 microns (30 to 50 mils) is generally ample to allow development of maximum abrasion resistance of the top coat layer. An elastomeric primer coat layer of 500 to 1300 microns (20 to 50 mils) thick may be particularly preferred. In other words, we are targeting 750 to 1000 microns (30 to 40 mils) for the primer coat layer and approximately the same 750 to 1000 microns (30 to 40 mils) for the top coat. It is important for these respective coatings to be of substantially even thickness. This can be done using the Monchamp '262 patent application for solvent-free spray system. This is to minimize stress concentration points and avoid the risk of delamination, cracking or chemical attack which tends to occur where coatings are too thin, too thick and at or near where there are sudden thickness changes.

For some applications, the elastomeric primer coat layer can be foamed to high thicknesses, ranging from 5 mm to 100 mm (¼ inch to 4 inches) thickness. This is useful for situations such as in northern climates where the fluids are to be prevented from freezing while held in steel equipment. Normal practice is to insulate the outside of steel tanks such as those used for holding fracking fluids. However, such external insulation is easily damaged and the present invention includes the option of foaming the primer coat layer as a means of applying a layer of insulation on the inside of the vessels such that the external steel helps to protect the insulation layer from the elements and from handling stresses. It becomes more difficult to maintain even coating thicknesses with such a thick insulating primer coat layer although still practicable.

The elastomeric primer coat layer can be applied directly to the prepared rigid or semi-rigid substrate, which may for example be a tank, pipe, tube or hull of steel, aluminium or glass fibre-reinforced plastics or a static structure of concrete or steel. The elastomeric primer coat layer can alternatively be applied over an anticorrosive protection layer on the substrate or over an existing layer of anticorrosive paint on the substrate. It can also be applied over a previously coated substrate, even one coated with the composite composition of the present invention. This is important in the case of making repairs and also for rehabilitating previously coated substrates where much of the prior existing coating remains relatively intact.

As is the case in Slater '603, “the elastomeric primer coat layer can be unpigmented, or may be pigmented and/or plasticised to achieve the desired physical properties such as hardness, extensibility and resilience. Examples of pigments are CaCO₃, kaolin, calcined clay, TiO₂, an oxide of iron, zinc or chromium, zirconia, magnesia, alumina, boron nitride lithopone, barium metaborate, BaSO₄ or colouring pigments such as phthalocyanine pigments. The pigments are generally of particle size 0.1 to 60 microns. Reinforcing fillers such as fumed silica of particle size below 0.1 micron can also be used. If the elastomeric primer coat layer is applied to a steel substrate without an anticorrosive primer, the elastomeric primer coat layer preferably contains an anticorrosive pigment such as a phosphate pigment. The concentration of pigment in the dry film is generally less than 35% by volume and preferably less than 25%, for example 1 to 25%.”

To a limited extent, the Slater '603 disclosure describes a suitable primer coat layer for the present invention except that it teaches away from the present invention when considering the top coat in Slater '603 is softer than the undercoat disclosed therein (opposite to the present invention in which the top coat is harder than the primer coat layer), and the top coat of the present invention becomes too fragile relative to the primer coat layer of the present invention at the softer and more flexible end of the Slater '603 ranges.

A particularly preferred elastomeric primer coat layer, as disclosed in Roosen '490, consists of a plural component gypsum composition that contains approximately 50% PBW (parts by weight) gypsum in total and is typically prepared in two parts with Part A being the gypsum, castor oil and various other ingredients totalling 85% PBW and Part B being the balance 15% polymethylene polyphenyl isocyanate that contains diphenylmethane diisocyanate, commonly known as MDI. This preferred primer coat layer has high pull-off strength relative to tensile strength, in the 98 to 100% range, which can allow for the lower NACE-3 standard for surface preparation to be used for steel substrates. The minimum tensile strength and pull-off strength (both being roughly equal) is 1.5 MPa (250 psi) with the preferred minimum being approximately 6 MPa (800 psi).

The top coat coat layer can be comprised of either a thermoplastic or thermosetting composition. The top coat layer can be applied as a solution, emulsion or dispersion of a thermoplastic or thermoset material. More preferably, it can be applied using a plural component solvent-free spray system as disclosed in the Monchamp '262 patent application.

Due to the high chemical resistances and the fact that that epoxy type coatings are generally accepted and widely used within the oil and gas and other industries, this is the preferred type of composition used for the top coat layer in the present invention. However, it is envisioned that there may be further improvements in chemical resistant coatings which, if they meet the engineering and cost requirements, would possibly become preferred over the epoxy type which is currently preferred.

Within the currently preferred epoxy type, those formulated as two part plural component systems that can be sprayed-in-place using conventional plural component sprayers or, more preferably, solvent-free spray equipment as disclosed in Monchamp '262 are more preferred. Those two component formulations made with epoxy resins derived from bisphenol-A, bisphenol-F reacted with epichlorohydrin to form diglycidal ethers as well as those which use epoxy resins of the epoxy phenol novalac or epoxy cresol novalac type, generally have sufficient chemical resistance and other properties when cured with appropriate curatives as are well known in the art. They are therefore preferred.

One relevant example from the art of a suitable preferred composition for the top coat layer in the present invention, as disclosed in U.S. Pat. No. 8,354,168 issued to Katsuyoshi Amidaiji in 2013, is a two part plural component epoxy composition (Epoxy Resin—part (A) and Curing Agent—part (B)). In his invention, it is designed to be spray-applied to a substrate as an anticorrosive base coat, then coated with an organopolysiloxane anti-fouling layer. His invention was directed toward use on ships and underwater structures—similar to the intended use for the invention disclosed in the Slater '603 patent.

Amidaiji '168 described his “Epoxy Resin (A) as a resin having two or more epoxy groups in one molecule, and the epoxy equivalent is desired to be in the range of 160 to 700, preferably 180 to 500. Examples of such epoxy resins include glycidyl ether epoxy resins, glycidyl ester epoxy resins, glycidyl amine epoxy resins, phenol novolak epoxy resins, cresol epoxy resins, dimer acid modified epoxy resins, aliphatic epoxy resins and alicyclic epoxy resins. Of these, bisphenol epoxy resins, particularly bisphenol A type epoxy resins, that are glycidyl ether epoxy resins are preferably used.”

“Examples of the epoxy resins of bisphenol A type include bisphenol A type diglycidyl ethers, such as bisphenol A diglycidyl ether, bisphenol A polypropylene oxide diglycidyl ether, bisphenol A ethylene oxide diglycidyl ether, hydrogenated bisphenol A diglycidyl ether and hydrogenated bisphenol A propylene oxide diglycidyl ether.”

“Examples of typical bisphenol epoxy resins include resins which are liquid at ordinary temperature, such as “Epicoat 828” (trade name, available from Shell Co., Ltd., epoxy equivalent: 180 to 190), “Epotohto YDF-170” (trade name, available from Tohto Kasei Co., Ltd, epoxy equivalent: 160 to 180) and “Flep 60” (trade name, available from Toray Thiokol Co., Ltd., epoxy equivalent: about 280); resins which are semi-solid at ordinary temperature, such as “Epicoat 834” (trade name, available from Shell Co., Ltd., epoxy equivalent: 230 to 270) and “Epotohto YD-134” (trade name, available from Tohto Kasei Co., Ltd., epoxy equivalent: 230 to 270); and resins which are solid at ordinary temperature, such as “Epicoat 1001” (trade name, available from Shell Co., Ltd., epoxy equivalent: 450 to 500). These epoxy resins can be used singly or in combination of two or more kinds.”

Amidaiji '168 further disclosed his “Curing agent (B) for epoxy resins is used for curing the above epoxy resin, and an amine curing agent which can react with the above epoxy resin to cure the resin is preferably used. Examples of such amine curing agents include hitherto known curing agents for epoxy resins, such as modified polyamine curing agents, polyamide curing agents and modified polyamide curing agents.”

“Examples of the modified polyamine curing agents include modification products of polyamines such as aliphatic polyamines, alicyclic polyamines, aromatic polyamines, specifically, metaxylenediamine, isophoronediamine, diethylenetriamine, triethylenetetramine and diaminodiphenylmethane. More specifically, there can be mentioned, for example, aliphatic, alicyclic or aromatic polyamines wherein polyamines have been modified by epoxide addition, Michael addition, Mannich addition, thiourea addition, acrylonitrile addition and ketone capping.”

“These modified polyamines, polyamides and modification products of polyamides desirably have an amine value of usually 50 to 1000 preferably 80 to 500. When the amine value of the curing agent is in this range, a balance between drying property and adhesion tends to be improved. These curing agents are usually liquid to solid. The polyamide curing agents are, for example, polyamides obtained by the reaction of diner acid with amines. Examples of the amines include the aforesaid aliphatic polyamines alicyclic polyamines and aromatic polyamines. More specifically, there can be mentioned, for example, “Lackamide N-153” (trade name, available from Dainippon Ink & Chemicals Inc., amine value: 80 to 120), “Lackamide TD-966” (trade name, available from Dainippon Ink & Chemicals Inc., amine value: 150 to 190) and “Sanamide 315” trade name, available from Sanwa Chemical Industry Co., Ltd., amine value 280 to 340).”

“The modified polyamide curing agents include modification products of the polyamides, and specifically, there can be mentioned, for example, “PA-23” (trade name, available from Ohtake Chemical Co. Ltd., amine value 80 to 150, that is an epoxy adduct obtained by the addition reaction of polyamide with an epoxy compound, and “Adeca Hardener EH-350” (trade name, available from Asahi Electro-Chemical Co., Ltd., amine value: 320 to 380) that is a Mannich modification product of modified polyamide.”

“Of the above polyamides and modification products thereof, an adduct of an epoxy compound is preferably used. The above-mentioned modified polyamines, polyamides and modification products of polyamides can be used singly or in combination of two or more kinds.”

However, Amidaiji '168 diverges from industry norms and the particular needs of the present invention by introducing a non conventional “Modifier (C)” component which teaches away, particularly when considering that such modifiers tend to reduce the highly desired excellent chemical resistance properties of the present invention. High chemical resistance is not as important for marine applications as for other uses such as coatings for equipment used in oil and gas industry fracking operations.

When destructive pull-off tests are performed on the fully cured composite coating composition applied to a particular substrate, the expectation of the present invention is to have cohesive failure within the primer coat layer or, in instances where the substrate material has lower tensile strength than the primer coat layer, for failure to occur within the substrate—not at the interface.

One aspect of a preferred inspection regime in the United States is to measure coating thicknesses as each of the layers are cured, to determine that they fall within acceptable ranges. The preferred range is 20 mils −5/+20 mils (1 mil=0.0254 mm) for the primer coat layer and 30 mils −10/+20 mils for the top coat layer. This gives a nominal 50 mils aggregate coating thickness ranging down to 35 mils and up to 90 mils (combined) on the suitably prepared substrate. Thicker coatings ranging up to approximately 1 cm (500 mils) or even greater are possible for some applications, especially those where coatings become structural such as in rehabilitating old sewer manholes or pipe where the substrates often undergo severe erosion and need to be built up to previous thickness as part of rehabilitation procedures.

Lab testing has shown that in equipment in which the top coat layer is too thin for a particular application, chemical contents can penetrate through the thin top coat layer and into the primer coat layer. This has become evident through analysis of samples and measurements taken after coated substrates have been in service for some time. For example, tanks with only 15 mils thick top coat layers containing very strong concentrations of hydrochloric acid (36% concentration) or mixtures of strong acids and hydrocarbons (hydrochloric acid, hydrofluoric acid and xylene) showed some penetration into the primer coat layer after several months of either continuous or intermittent service. A continuous service is one in which there is no break in chemical loading such as in storage tank applications. An intermittent service is one in which loads are cycled such as in tank trailers or railcars in which they are emptied and loaded. Thicker top coat layers (20 mils or greater) showed no such penetration into the primer coat layer. However, the primer coat layer provides an additional defense against chemical attack. In the event of a top coat failure in the case of a chemical attack, the primer coat layer may have sufficient resistance to protect the substrate from said chemical(s).

In addition to visual inspection and taking thickness measurements, it is common practice to use high voltage pulsed direct current testing equipment, often referred to as spark testers, to check for defects in coated substrates. X-ray and other types of non-destructive testing as well as destructive tensile/elongation, pull-off strength, chemical resistance tests can be conducted to ensure integrity of the coated substrate.

Care needs to be taken to ensure coated substrates are not damaged before or during service through excessive mechanical stress or otherwise. Cleaning procedures need to be established to ensure cleaning equipment or procedures do not damage the coated substrate. For instance, steam cleaning can become quite problematic if temperatures exceed the thermal limits for the composite coating composition.

The improved coating composition of the present invention compares favorably with the current longevities of the coatings described in the prior art, particularly those used in fracking equipment. Longevities are again being measured in years rather than months in spite of the increased acidization levels of current fracking practices.

Detailed analysis reveals that, unlike the case for traditional coatings, minor breaches in the coatings of the present invention do not quickly lead to large failures. The elastomeric primer coat layer greatly reduces the tendency for corrosive fluids to run between the steel or other substrate and the top coat layer. It is an unexpected result that upon close examination seems due to the elastomeric primer coat layer tending to hold the top coat layer in place such that it tends not to delaminate and allow fluids to freely move around behind the coatings. Chemical reaction products of the substrate, fluids being contained and, in some instances, the coating material itself, tend to build up in these localized areas, behind the top coat layer, with said reaction products interfering with and diminishing the rate of further chemical reactions. Although the elastomeric primer coat layer generally has lower chemical resistance than the top coat layer, it tends to become displaced by chemical reaction products. These reaction products create a barrier. In contrast, traditional epoxy linings tend to curl away or otherwise delaminate from the substrate. This allows for the corrosive fluids being contained to freely migrate and rinse chemical reaction products from the relatively large areas of exposed substrate.

The coating composition of the present invention can also be used on top of existing coatings as well as for patching or repairing itself. For instance, it is normal practice for equipment to be inspected and serviced on occasional or regular intervals to have repairs made where needed. To effect such a repair using the composite composition of the present invention, any loose prior coatings would need to be removed by sand blasting or other means, then coated using the two respective layers. In cases where there is only a minor repair, or where only the top coat has a defect and the primer coat layer remains intact, or where a previous coating of a different type remains intact, minimum surface preparation is needed. Manually cleaning and sanding the area prior to applying new coating material may be sufficient in such instances. The elastomeric primer layer material may need to be checked for compatibility with existing coatings made from different types of materials. For instance, it has been found that the composite composition can be successfully applied to epoxy and also to butyl rubber lined steel vessels that have been lightly sand blasted.

For patching, repairs or recoating specific areas, it is important to not have the edges of the patches feathered out into the surrounding coating area. There is a strong tendency for the thin edges to separate which is greatly reduced or eliminated by masking the area immediately surrounding that area being patched, repaired or recoated and applying the primer coat layer and top coat layer respectively to the previously specified thicknesses, generally a minimum 500 microns (20 mils) each layer. The thinner portions of the coating separating seems to be due to the penetration of one or more corrosive chemicals partially into the surface causing localized shrinking and/or swelling, often of a cyclical nature as vessels are loaded and unloaded. This effect is overcome when there is sufficient coating thickness to maintain overall coating integrity. The separation of thin edges may not be of concern relative to the overall coating integrity where there is sufficient coating thickness of the area surrounding the core of the patch or repair, but it certainly creates an undesirable appearance.

While the invention has been disclosed in its preferred form, the specific embodiments thereof as disclosed herein are not to be considered in a limiting sense, because numerous variations are possible. The subject matter of the invention includes all novel and non-obvious combinations and subcombinations of the various elements, features, functions, and/or properties disclosed herein. No single feature, function, element, or property of the disclosed embodiments is essential. The following claims define certain combinations and subcombinations which are regarded as novel and non-obvious. Other combinations and subcombinations of features, functions, elements, and/or properties may be claimed through amendment of the present claims or presentation of new claims in this or a related application. Such claims also are regarded as included within the subject matter of the present invention irrespective of whether they are broader, narrower, or equal in scope to the original claims. This invention also covers all embodiments and all applications which will be immediately comprehensible to the expert upon reading this application, on the basis of his or her knowledge and optionally simple routine tests.

I claim:

1. A rigid or semi-rigid substrate having a composite protective coating comprising:
an elastomeric primer coat layer of even thickness greater than 250 microns bonded to the surface being coated, and
a top coat layer of even thickness between 500 and 2500 microns bonded to said primer coat layer,
wherein said top coat layer is harder than said primer later.

2. A composite protective coating according to claim 1, wherein the primer coat layer has a Shore D hardness of 20 to 60 and the top coat layer has a Shore D hardness of 60 to 95.

3. A composite protective coating according to claim 1, wherein the primer coat layer has an extensibility of 20 to 300% and the top coat layer has an extensibility of less than 20%.

4. A composite protective coating according to claim 1, wherein the primer coat layer is applied as a layer is between 500 and 1300 microns thick.

5. A composite protective coating according to claim 1, wherein the primer coat layer comprises an elastomeric polyurethane, polyurea or poly(urethane-urea).

6. A composite protective coating according to claim 1, wherein the primer coat layer and/or the top coat layer comprises a plural component coating formulation.

7. A composite protective coating according to claim 1, wherein the primer coat layer and/or the top coat layer comprises a coating formulation that does not include any solvents.

8. A composite protective coating according to claim 1, wherein the top coat layer comprises a coating formulation that has a coefficient of linear thermal expansion relatively close to that of the substrate being coated.

9. A composite protective coating according to claim 1, wherein the top coat layer comprises a coating formulation that has a coefficient of linear thermal expansion no more than twice that for steel and concrete substrates.

10. A composite protective coating according to claim 1, wherein the primer coat layer has a pull-off strength equal or nearly equal to its tensile strength (e.g. 98 to 100%).

11. A composite protective coating according to claim 1, wherein the primer coat layer has a pull-off strength at least 98% of its tensile strength.

12. A composite protective coating according to claim 1, wherein either or both the primer coat layer and the top coat layer includes fiber reinforcement material.

13. A composite protective coating according to claim 1, wherein the elastomeric primer coat layer is a foam of 5 mm to 100 mm thickness

14. A method of providing a rigid or semi-rigid substrate with a composite protective coating comprising:
applying an elastomeric primer coat layer of even thickness between 250 and 1300 microns to the substrate, and
applying a top coat layer of even thickness between 500 and 2500 microns bonded to said primer coat layer,
wherein said top coat layer, after curing, is harder than said primer coat layer.

15. A method according to claim 14, wherein at least one if the layers is applied with a solvent-free plural-component spraying system having
a set of ratio proportioning pumps for delivering two or more respective components of a plural component fluid formulation under pressure;
a heating system to heat said respective fluid components;
a mixing and dispensing apparatus into which said respective fluid components enter under pressure which includes an impingement mixing element, a backpressure element, a static mixer housing that contains one or more static mixing elements and an orifice portion from which mixed material is dispensed;
wherein
said impingement mixing element of said mixing and dispensing apparatus has entry ports and a mixing chamber configured such that said respective fluid components enter under pressure and initially mix by impingement mixing;
said orifice portion of said mixing and dispensing apparatus is located downstream of said static mixer housing;
said backpressure element is located between the respective fluid component entry ports of the impingement mixing element and said orifice portion;
the static mixer housing is easily and quickly removable to facilitate replacement of the static mixing element(s);
said system further comprising
a device for observing and adjusting the pressures developed by said set of ratio proportioning pumps;
temperature controllers for said fluid components;
a device for setting and maintaining a set ratio between said proportioning pumps.

16. A method according to claim 14, wherein the surface of the substrate is prepared to the NACE-3 standard prior to applying the primer coat layer.

17. A method according to claim 14, wherein the elastomeric primer coat layer is applied to a previously coated substrate.

18. A method according to claim 17, wherein the substrate has been previously coated with an anticorrosive layer.

19. A method according to claim 14, wherein the substrate to be coated has been previously coated, wherein the composite protective coating serves to repair or patch over the previous coating.
